(19) United States
(12) Patent Application Publication
(10) Pub. No.: US 2025/0051875 A1
(43) Pub. Date: Feb. 13, 2025

(54) HYDROGEN-BASED VALORISATION OF METAL-CONTAINING FEED MATERIALS TO EXTRACT METALS

(71) Applicant: LIFEZONE LTD, Ramsey (GB)

(72) Inventors: Keith Stuart Liddell, Normandy (GB); Michael David Adams, Phuket (TH)

(21) Appl. No.: 18/723,405

(22) PCT Filed: Nov. 29, 2022
(86) PCT No.: PCT/IB2022/061519

§ 371 Date: Jun. 21, 2024

(30) Foreign Application Priority Data
Dec. 23, 2021 (GB) 2118901.4

(51) Int. Cl. C22B 3/08; C21B 13/00; C22B 3/00; C22B 3/10; C22B 3/22; C22B 11/00; C22B 15/00

(52) U.S. Cl. CPC C22B 3/08; C21B 13/006; C22B 3/10; C22B 3/22; C22B 11/04; C22B 15/0069; C22B 23/043

(57) ABSTRACT

This invention describes a hydrometallurgical process for extracting and recovering valuable metals contained within metalliferous minerals including ores, concentrates and other materials and generation of useful by-products including sulfur, calcium, oxygen, carbon and hydrogen, wherein the process comprises the use of a hydrogen generator, such as an water electrolyser, hydrocarbon pyrolyser or reformer to produce hydrogen, and optionally carbon and oxygen integrated into a single circuit that converts the CO₂ and SO₂ pollutants that would be emitted by the conventional pyrometallurgical process into the useful by-products.

### FIELD OF THE INVENTION

This invention relates to a hydrometallurgical process for extracting and recovering valuable metals contained within metalliferous minerals including ores, concentrates and other materials and generation of useful by-products including sulfur, calcium, oxygen, carbon and hydrogen, wherein the process comprises the use of a hydrogen generator, such as an water electrolyser, hydrocarbon pyrolyser or reformer to produce hydrogen, and optionally carbon and oxygen integrated into a single circuit that converts the CO₂ and SO₂ pollutants that would be emitted by the conventional pyrometallurgical process into the useful by-products. The process further converts iron-rich waste from the process into “green steel” or a precursor thereof. In particular, the process may be integrated into one or more existing valuable element extraction processes. In a further possible embodiment of the invention, use of a brine electrolyser may be included in the process to produce reagents such as chlorine, sodium hypochlorite, sodium chlorate, hydrochloric acid or caustic soda, or their halogen or alkali metal analogues, for use in the leach steps and/or in the metals recovery processes, or which may be recovered for sale.

### BACKGROUND OF THE INVENTION

Feedstocks containing multiple valuable metals or other saleable materials present a metallurgical and environmental challenge to the recovery and separation of such valuable elements into commercially feasible products using conventional processing techniques based on pyrometallurgy, as these generally produce undesirable or polluting emissions. This is typically the case for feedstocks containing valuable metals such as platinum group metals (PGMs), gold or silver, and other valuable base and rare metals such as nickel, cobalt, copper, lithium, rare earth elements (REE), yttrium and scandium, and uranium, thorium, manganese, zinc, cadmium, molybdenum, titanium, tin, and other minor elements such as vanadium, germanium and gallium.

It would be useful if alternative hydrometallurgical processes might be developed for the extraction and recovery of such valuable metals and other valuable by-products containing elements such as sulfur, calcium, carbon, oxygen, and hydrogen, that could simultaneously mitigate or overcome polluting emissions and wastes, and/or be used as recycled elements in the hydrometallurgical processes, thereby to facilitate the commercial feasibility and improve environmental impact of such extraction and recovery processes.

### SUMMARY OF THE INVENTION

According to a first embodiment of the invention there is provided a hydrometallurgical process for extraction and recovery, from a feed material or blend of feed materials, of one or more valuable metals or elements comprising or consisting of: precious metals selected from a group comprising or consisting of platinum group metals (PGMs) i.e. platinum, palladium, rhodium, iridium, ruthenium, osmium, gold and silver; base metals selected from a group comprising or consisting of aluminum, copper, lead, nickel, cobalt, tin, tungsten, zinc, cadmium and manganese, but most particularly nickel, cobalt, copper and zinc; and optionally rare elements selected from a group comprising or consisting of rare earth elements, lithium, germanium, gallium, indium, scandium and other nominal valuable metals that may be worth recovering, including uranium, thorium, molybdenum and vanadium,
wherein iron-rich waste in the feedstock is converted into “green steel” or a precursor (14), and
wherein CO₂ and SO₂ pollutants emitted by the hydrometallurgical process are converted into by-products for sale, are used as feed material in further process(es), or are recycled within the hydrometallurgical process, the process comprising or consisting of the following steps:
   (i) generating hydrogen and optionally carbon and/or oxygen products with the use of a hydrogen generator (12), including by electrolysis of water or hydrocarbon pyrolysis or reforming, including with the use of renewable energy or waste sources;
   (ii) leaching (18) the feed material or the blend of feed materials (16), selected from a group comprising or consisting of a sulfide or other concentrated ore, an oxide or laterite ore, a leach residue or a pre-conditioned leach residue, or any combination thereof, under pressure and/or atmospheric conditions and oxidative, neutral or reductive conditions to generate a slurry (20) comprising metal sulfates and other valuable elements in solution (24) and a solid leach residue (26) comprising valuable metals and other valuable elements, in particular, where the feed material or blend of feed materials (16) is in the form of a mineral sulfide concentrate, pressure or atmospheric oxidative leaching (18) the feed material or blend (16) to generate a slurry (20) comprising metal sulfates and other valuable elements in solution (24) and a leach residue (26) comprising valuable metals and other valuable elements;
   (iii) separating (22) using using filtration, thickening, centrifugation/cycloning, particle size separation techniques, gravity separation, electrostatic separation, or other standard physical separation methods, the solid leach residue (26) from the solution (24) in the leach slurry (20);
   (iv) neutralising and purifying (28), by addition of limestone and optionally air enriched with oxygen generated from the electrolysis (12), the separated solution (24), thereby to form a slurry comprising solid gypsum (30) and iron oxide (32) products and releasing carbon dioxide;
   (v) optionally, capturing released carbon dioxide produced during the neutralising and purifying step (28) further optionally using scrubbing agents including amines;
   (vi) separating (34) the solid gypsum (30) and iron oxide (32) products using filtration, thickening, centrifugation/cycloning, particle size separation techniques, gravity separation, electrostatic separation, or other standard separation methods from each other and from the purified metals (36);
   (vii) recovering (38) the purified metals (36) after separation including by solvent extraction, ion exchange, adsorption, precipitation, cementation, electrowinning or reduction (40);
   (viii) optionally reacting (42) carbon dioxide produced or captured, including with the use of scrubbing agents, during the neutralising and purifying step (28) with hydrogen generated by the hydrogen generator (12) to form methanol (44) for sale, storage, or recycling into step (i), including with the use of a process as disclosed in US patent publication no. US20170166503A1 or other known processes;
   (ix) optionally, alternatively or in addition, utilising the carbon dioxide produced or captured, including with the use of scrubbing agents, during the neutralising and purifying step (28) in an algal production system (46);
   (x) recovering remaining iron oxide (32) from the solid leach residue (26), of step (iii), including optionally subjecting the solid leach residue (26) to heat treatment (54) under reducing, neutral or oxidising conditions to form a heat-treated calcine residue, followed by an additional separation (48) using filtration, thickening, centrifugation/cycloning, particle size separation techniques, gravity separation, magnetic, electrostatic separation, or other standard separation methods, of the solid iron oxide (32) from the calcine residue, leaving a remaining siliceous residue (50) optionally comprising valuable metals and other elements for further purification;
   (xi) reacting (52) the separated iron oxide products (32) from step (vi) and step (x) including by a molten salt electrolysis route (such as that described in US Pat. No. U.S. Pat. No. 8,764,962B2) to produce oxygen, or alternatively by hydrogen reduction using hydrogen generated by the hydrogen generator (12), to produce Direct Reduced Iron (DRI) or sponge iron, thereby forming “green steel” or a precursor (14) and optionally oxygen, depending on the “green steel” or precursor production process used; and
   (xii) optionally capturing released oxygen, when produced in step (xi), for reuse in the hydrometallurgical process.

Oxygen generated from water electrolysis (12) when used in step (i), and/or if generated in the iron reduction step (xi) may be used in step (ii).

In step (vii), the reduction (40) may be performed using hydrogen from the hydrogen generation step (12).

In particular, in step (viii), the methanol may be recycled to the hydrogen generation step (i) to generate carbon, including for processing to form a stable saleable by-product such as carbon black, graphite, graphene or carbon nanotubes, as well as hydrogen and oxygen for use in the hydrometallurgical processes.

For step (xi), the reaction process may include the use of renewable energy sources to produce the “green steel” or precursor.

For step (ii), in the case where significant jarosite or basic ferric sulfate is present in the solid residue (26), the leach slurry (20) is optionally subjected to a conditioning step to leach iron sulfates into solution.

Optionally, step (iv) may further include a step of partial reduction of the slurry using hydrogen produced by the hydrogen generator (12) or another reductant, to form one or more magnetic iron phases that can be separated from the gypsum (30) by magnetic separation.

Recovery (38) of the purified metals (36) of step (vii) may be performed between step (iii) and step (iv), rather than after step (iv) in the case where the purified metal (36) is copper.

Optionally, step (iv) may be followed by a secondary neutralisation step by addition of limestone and/or hydrated or dry lime to produce a slurry comprising a nickel-cobalt/iron mixed hydroxide precipitate and gypsum. The slurry may be subjected to filtration, thickening, centrifugation/cycloning, particle size separation techniques, gravity separation, magnetic, electrostatic separation, or other standard separation methods thereby to separate the gypsum from the nickel-cobalt/iron mixed hydroxide precipitate. In an alternative to this secondary neutralisation step, to effect separation of nickel in particular, the nickel-cobalt/iron mixed hydroxide precipitate and gypsum slurry, or separated solid nickel-cobalt/iron mixed hydroxide precipitate and gypsum is subjected to an oxidising leach step with sulfuric acid, to yield gypsum, manganese for disposal or recovery by any one of the methods in step (vii), nickel for recovery by any one of the methods in step (vii) and and cobalt which may be re-leached in a further leach step.

The gypsum after the separation step above may be subjected to sulfuric acid washing, followed by recycling to step (vii) to recover entrained nickel and cobalt in the gypsum and to produce a gypsum product for disposal or sale. The sulfuric acid may be fresh, or alternatively may be recycled sulfuric acid from the separated solution (24) before the neutralisation step (iv), or recycled from other sulfuric acid streams within the process of the invention.

The nickel-cobalt/iron mixed hydroxide precipitate after the separation step above may be subjected to sulfuric acid releaching to produce a solution comprising nickel and cobalt sulfates and an iron oxide hydrate containing impurity metals such as manganese, for disposal or advancing to step (vii). The sulfuric acid may be fresh, or may be recycled electrolyte from a nickel electrowinning step, or may be recycled from other sulfuric acid streams within the process of the invention.

Depending on the feed material(s) used, further steps may be incorporated into the above process of the invention. For example, more particularly:
in the case where the feedstock is a copper-gold-silver sulfide concentrate the process may consist of the following steps:
   a) performing steps (i) to (iv), (vi) to (viii) and (x), and optionally steps (v), (ix) and/or (xii), but recovery of copper in step (vii) between steps (iii) and (iv), rather than after step (iv), and optionally performing an additional step of heat-treating (54) the separated leach residue (26) from the pressure or atmospheric oxidation leaching (18) after step (iii), thereby to to volatilize any carbonaceous minerals, optionally capturing CO₂ from the heat-treatment (54) using amines or other suitable scrubbing agents as per step (v), and optionally recovering residual sulfur by sublimation and condensation;
   b) repeating steps (ii) to (iv), (vi) to (viii) and (x), and optionally steps (v), (ix) and/or (xii), but using a non-oxidative HCl leach in step (ii), to yield a gold-rich siliceous residue after repeated step (x), and to recover silver metal in repeated step (vii), wherein in the separation step (vi) (34), hydrochloric acid is recovered by distillation for recovery or recycling into the process, the gypsum product (30) is precipitated for recovery, and silver metal (36) is separated by adsorption or other method and recovered (38) by electrowinning or reduction (40), optionally with hydrogen generated by the the hydrogen generator (12) of step (i) or further optionally by brine electrolysis (56);
   c) subjecting the gold-rich siliceous residue of step (b) to oxidative HCl leaching in step (ii) with oxidizing leach reagent produced via the hydrogen generator (12) of step (i) or optionally by brine electrolysis (56), followed by repeating steps (iii) to (iv), (vi) to (viii) and (x), and optionally steps (v), (ix) and/or (xii), wherein in the separation step (vi) (34) sulfuric acid is added to the purified metals (36) to remove calcium, hydrochloric acid is recovered by distillation for recovery or recycling into the process, a gypsum product (30) is precipitated for recovery, and gold metal is separated by adsorption or other method and recovered by electrowinning or reduction (40), optionally with hydrogen generated by the hydrogen generator (12) of step (i) or further optionally by brine electrolysis (56).

Alternatively in the case where the feedstock is a nickel sulfide flotation concentrate containing gold and PGMs, more particularly the process may consist of the following steps:
(A) performing steps (i) to (iv), (vi) to (viii) and (x), and optionally steps (v), (ix) and/or (xii), to generate a gold/PGM-rich siliceous residue after step (x);
(B) heat-treating the gold/PGM-rich siliceous residue from step (x) using hydrogen generated by the hydrogen generator (12) of step (i) and optionally capturing CO₂ from the heat-treatment using amines or other suitable scrubbing agents as per step (v), and optionally recovering sulfur by sublimation;
(C) repeating steps (ii) to (iv), (vi) to (viii) and (x), and optionally steps (v), (ix) and/or (xii), but using a non-oxidative HCl leach in step (ii), to yield a gold/PGM-rich siliceous residue after repeated step (x), and to remove gangue and base metals in repeated step (vii), wherein in the separation step (vi) (34), hydrochloric acid is recovered by distillation for recovery or recycling into the process, a gypsum product is precipitated for recovery, and base metals are recovered into an intermediate product for further processing by recycling into step (A);
(D) subjecting the gold/PGM-rich siliceous residue of (D) to oxidative HCl leaching in step (ii) with oxidizing reagent produced via the hydrogen generator (12) of step (i), or optionally by brine electrolysis (56), followed by repeating steps (iii) to (iv), (vi) to (viii) and (x), and optionally steps (v), (ix) and/or (xii), wherein after step (vi) (34), hydrochloric acid is recovered by distillation or direct recycling of solution into step (C) for recovery or recycling into the process, a gypsum product (30) is precipitated for recovery, and after separation by ion-exchange, solvent extraction or other suitable methods, gold and PGM metals are recovered by reduction (40), optionally with hydrogen generated by the hydrogen generator (12) of step (i) or further optionally by brine electrolysis (56).

Optionally, in either or both of (A), (C) or (D) above, step (iv) may be followed by a secondary neutralisation step by addition of limestone and/or hydrated or dry lime to produce a slurry comprising a nickel-cobalt/iron mixed hydroxide precipitate and gypsum.

As indicated in the processes above, there is an optional additional inclusion in the process of a brine electrolyser (56), to produce reagents for use in the leach or metals recovery unit processes, or for sale, including using renewable energy or waste sources for the reagent generation.

The feed material ore, concentrate, or residue may be initially processed by crushing, milling or may be as-mined. Alternatively, or in addition, the feed material may be subjected to a beneficiation step to produce an intermediate ore product for providing to the reaction vessel. The beneficiation step may be performed by a combination of crushing, grinding, screening, sizing, classification, magnetic separation, electrostatic separation, froth flotation or gravity separation thereby to concentrate the valuable metals or reject a gangue component, or by other means of beneficiation known to those skilled in the art.

The heat treatment may be performed at from or about 80-750° C. for up to 120 minutes, typically at from or about 300-700° C. for 10 to 30 minutes, under oxidizing, neutral or reducing conditions, to remove volatile components from the solid residue, optionally including sulfur, and reduce or negate any preg-robbing attributes of the material, whilst rendering refractory mineral phases such as PGM-bearing minerals or silver jarosites suitable for recovery by subsequent leaching.

An additional second heat-treatment may be performed at from or about 500-1000° C. for up to 120 minutes, typically at from or about 700-1000° C. for 30 to 120 minutes, under oxidizing, neutral or reducing conditions, to condition saleable metals to be soluble in chloride leaching medium.

A third additional heat-treatment may be performed at from or about 100-600° C. for up to 240 minutes, typically at from or about 100-400° C. for 60-180 minutes, under oxidizing, neutral or reducing conditions, to further condition saleable metals to be soluble in chloride leaching medium.

The thermal processes may be performed as individual steps of a sequential thermal treatment process, or as one combined step. The thermal processes may be fired by hydrogen generated by the hydrogen generator (12) of step (i), by liquid natural gas or another hydrocarbon fuel, by renewable electricity or a combination thereof. Hydrogen generated by the hydrogen generator (12) of step (i), from a hydrocarbon fuel or from syngas may be used to provide the reducing atmosphere if required.

### BRIEF DESCRIPTION OF THE DRAWINGS

The invention will now be further described, by way of example, with reference to the accompanying drawings.

FIG. 1 is a simplified block flowsheet diagram of a generic embodiment of the process of the invention;

FIG. 2 is a simplified block flowsheet diagram illustrating further detail of one specific example of the process of the invention for extraction of valuable elements from a primary nickel sulfide flotation concentrate;

FIG. 3 is a simplified block flowsheet diagram illustrating further detail of one specific example of the process of the invention for extraction of valuable elements from a primary nickel oxide ore and sulfide concentrate;

FIG. 4 is a simplified block flowsheet diagram illustrating further detail of one specific example of the process of the invention for extraction of valuable elements from a primary nickel oxide ore;

FIG. 5 is a simplified block flowsheet diagram illustrating further detail of one specific example of the process of the invention for extraction of valuable elements from a copper-gold-silver sulfide concentrate;

FIG. 6 is a simplified block flowsheet diagram illustrating further detail of one specific example of the process of the invention for extraction of valuable elements from a gold-silver sulfide concentrate;

FIG. 7 is a simplified block flowsheet diagram illustrating further detail of one specific example of the process of the invention for extraction of valuable elements from a gold-silver-rich leach residue;

FIG. 8 is a simplified block flowsheet diagram illustrating further detail of one specific example of the process of the invention for extraction of valuable elements from a gold-rich leach residue;

FIG. 9 is a simplified block flowsheet diagram illustrating further detail of one specific example of the process of the invention for extraction of valuable elements from a primary nickel-PGM sulfide concentrate;

FIG. 10 is a simplified block flowsheet diagram illustrating further detail of one specific example of the process of the invention for extraction of valuable elements from a PGM-rich leach residue;

FIG. 11 is a chart depicting the time-dependent results of an experiment targeting the precipitation from HCl preleach liquor;

FIG. 12 is a simplified block flowsheet diagram illustrating further detail of the process of FIG. 10;

FIG. 13 shows the potential thermodynamics for a process of direct iron reduction with hydrogen;

FIG. 14 is a simplified block flowsheet diagram illustrating further detail of one specific example of the process of the invention for extraction of valuable elements from a PGM-rich leach residue, showing further detail of metals recovery from the gypsum and iron oxide products; and

FIG. 15 shows the dependence of metals solubility on pH value⁷.

### DETAILED DESCRIPTION OF THE INVENTION

This invention relates to a hydrometallurgical process for extracting and recovering valuable metals contained within metalliferous minerals including ores, concentrates and other materials and generation of useful by-products including sulfur, calcium, oxygen, carbon and hydrogen, wherein the process comprises the use of a hydrogen generator, such as an water electrolyser, hydrocarbon pyrolyser or reformer to produce hydrogen, and optionally carbon and oxygen integrated into a single circuit that converts the CO₂ and SO₂ pollutants that would be emitted by the conventional pyrometallurgical process into useful by-products. The process further converts iron-rich waste from the process into “green steel” or a precursor thereof. In particular, the process may be integrated into one or more existing valuable element extraction processes. In a further possible embodiment of the invention, use of a brine electrolyser may be included in the process to produce reagents such as chlorine, sodium hypochlorite, sodium chlorate, hydrochloric acid or caustic soda, or their halogen or alkali metal analogues, for use in the leach steps and/or in the metals recovery processes, or which may be recovered for sale. Preferably the water and brine electrolysers would utilise renewable energy sources including wind and solar resources.

Examples of by-products are exemplified herein, and include hydrogen and oxygen gases, and chemical derivatives including gypsum, which is a cement binder building material and additive to structural ground support paste used in underground mining; methanol, which is a chemical building block for hundreds of everyday products including plastics, paints, car parts and construction materials and which is also a clean energy resource used to fuel cars, trucks, buses, ships, fuel cells, boilers and cooking stoves, and carbon products, including carbon black, graphite, graphene and carbon nanotubes, as well as methanol.

“Green steel” means steel that has been produced using hydrogen rather than coal in the production process, thereby significantly reducing the carbon footprint for production of such steel. The production process preferably utilises renewable energy sources including wind and solar resources in the production process.

The following description of the invention is provided as an enabling teaching of the invention, is illustrative of the principles of the invention and is not intended to limit the scope of the invention. It will be understood that changes can be made to the embodiment/s depicted and described, while still attaining beneficial results of the present invention. Furthermore, it will be understood that some benefits of the present invention can be attained by selecting some of the features of the present invention without utilising other features. Accordingly, those skilled in the art will recognise that modifications and adaptations to the present invention are possible and can even be desirable in certain circumstances, and are a part of the present invention.

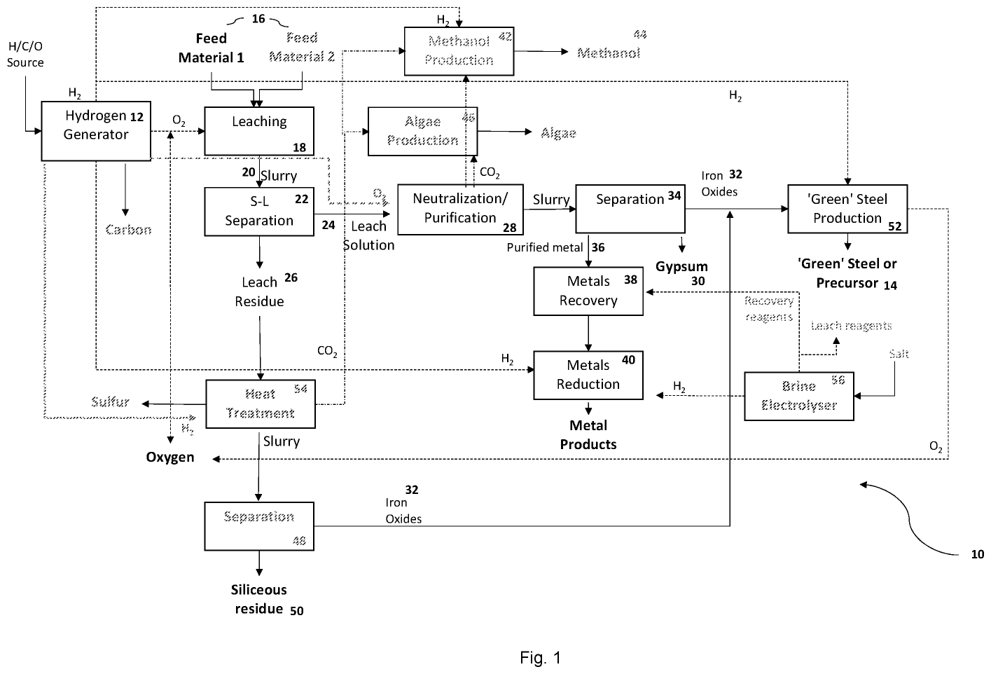

As illustrated in FIG. 1, the generic process of the invention (10) comprises integration of the hydrogen and oxygen products generated by a step of hydrogen generation, including through electrolysis of water, hydrocarbon pyrolysis or reforming (12), into a single circuit, that converts the CO₂ and SO₂ pollutants that would be emitted using conventional pyrometallurgical processing, into useful by-products, while converting iron-rich waste into green steel or a precursor (14) and metals into refined products. The first step comprises subjecting a feed material or optionally a blend of feed materials (16), which may be a sulfide or other concentrated ore, an oxide or laterite ore, a leach residue or a pre-conditioned leach residue, or any combination thereof, to a leaching step (18) under pressure and/or atmospheric conditions and oxidative, neutral or reductive conditions, to produce a product slurry (20) that is separated (22) into streams comprising valuable metals and other elements in solution (24) for recovery and a leach residue (26) containing valuable metals and other elements for recovery.

The feed material or blend of feed materials to be processed contain one or more valuable metals or elements comprising or consisting of: precious metals selected from a group comprising or consisting of platinum group metals (PGMs) i.e. platinum, palladium, rhodium, iridium, ruthenium, osmium, gold and silver; base metals selected from a group comprising or consisting of aluminum, copper, lead, nickel, cobalt, tin, tungsten, zinc, cadmium and manganese, but most particularly nickel, cobalt, copper and zinc; and optionally rare elements selected from a group comprising or consisting of rare earth elements, lithium, germanium, gallium, indium, scandium and other nominal valuable metals that may be worth recovering, including uranium, thorium, molybdenum and vanadium.

In particular, the process steps of the invention described above are set out in more detail below and as depicted in the block flow diagram of FIG. 1.

The process comprises or consists of the following steps:
(i) generating hydrogen and optionally carbon and oxygen products with the use of a hydrogen generator (12), including by electrolysis of water or hydrocarbon pyrolysis or reforming, including with the use of renewable energy or waste sources;
(ii) leaching (18) the feed material or the blend of feed materials (16), selected from a group comprising or consisting of a sulfide or other concentrated ore, an oxide or laterite ore, a leach residue or a pre-conditioned leach residue, or any combination thereof, under pressure and/or atmospheric conditions and oxidative, neutral or reductive conditions to generate a slurry (20) comprising metal sulfates and other valuable elements in solution (24) and a solid leach residue (26) comprising valuable metals and other valuable elements, in particular, where the feed material or blend of feed materials (16) is in the form of a mineral sulfide concentrate, pressure or atmospheric oxidative leaching (18) the feed material or blend (16) to generate a slurry (20) comprising metal sulfates and other valuable elements in solution (24) and a leach residue (26) comprising valuable metals and other valuable elements;
(iii) separating (22) using using filtration, thickening, centrifugation/cycloning, particle size separation techniques, gravity separation, electrostatic separation, or other standard physical separation methods, the solid leach residue (26) from the solution (24) in the leach slurry (20);
(iv) neutralising and purifying (28), by addition of limestone and optionally air enriched with oxygen generated from the electrolysis (12), the separated solution (24), thereby to form a slurry comprising solid gypsum (30) and iron oxide (32) products and releasing carbon dioxide;
(v) optionally, capturing released carbon dioxide produced during the neutralising and purifying step (28) further optionally using scrubbing agents including amines;
(vi) separating (34) the solid gypsum (30) and iron oxide (32) products using filtration, thickening, centrifugation/cycloning, particle size separation techniques, gravity separation, electrostatic separation, or other standard separation methods from each other and from the purified metals (36);
(vii) recovering (38) the purified metals (36) after separation including by solvent extraction, ion exchange, adsorption, precipitation, cementation, electrowinning or reduction (40);
(viii) optionally reacting (42) carbon dioxide produced or captured, including with the use of scrubbing agents, during the neutralising and purifying step (28) with hydrogen generated by the hydrogen generator (12) to form methanol (44) for sale, storage, or recycling into step (i), including with the use of a process as disclosed in US patent publication no. US20170166503A1 or other known processes;
(ix) optionally, alternatively or in addition, utilising the carbon dioxide produced or captured, including with the use of scrubbing agents, during the neutralising and purifying step (28) in an algal production system (46);
(x) recovering remaining iron oxide (32) from the solid leach residue (26), of step (iii), including optionally subjecting the solid leach residue (26) to heat treatment (54) under reducing, neutral or oxidising conditions to form a heat-treated calcine residue, followed by an additional separation (48) using filtration, thickening, centrifugation/cycloning, particle size separation techniques, gravity separation, magnetic, electrostatic separation, or other standard separation methods, of the solid iron oxide (32) from the calcine residue, leaving a remaining siliceous residue (50) optionally comprising valuable metals and other elements for further purification;
(xi) reacting (52) the separated iron oxide products (32) from step (vi) and step (x) including by a molten salt electrolysis route (such as that described in U.S. Pat. No. 8,764,962B2) to produce oxygen, or alternatively by hydrogen reduction using hydrogen generated by the hydrogen generator (12), to produce Direct Reduced Iron (DRI) or sponge iron, thereby forming “green steel” or a precursor (14) and optionally oxygen, depending on the “green steel” or precursor production process used; and
(xii) optionally capturing released oxygen, when produced in step (xi), for reuse in the hydrometallurgical process.

Oxygen generated from water electrolysis (12) when used in step (i), and/or if generated in the iron reduction step (xi) may be used in step (ii).

In step (vii), the reduction (40) may be performed using hydrogen from the hydrogen generation step (12).

In particular, in step (viii), the methanol may be recycled to the hydrogen generation step (i) to generate carbon, including for processing to form a stable saleable by-product such as carbon black, graphite, graphene or carbon nanotubes, as well as hydrogen and oxygen for use in the hydrometallurgical processes.

For step (xi), the reaction process may include the use of renewable energy sources to produce the “green steel” or precursor.

For step (ii), in the case where significant jarosite or basic ferric sulfate is present in the solid residue (26), the leach slurry (20) is optionally subjected to a conditioning step to leach iron sulfates into solution.

Optionally, step (iv) may further include a step of partial reduction of the slurry using hydrogen produced by the hydrogen generator (12) or another reductant, to form one or more magnetic iron phases that can be separated from the gypsum (30) by magnetic separation.

Recovery (38) of the purified metals (36) of step (vii) may be performed between step (iii) and step (iv), rather than after step (iv) in the case where the purified metal (36) is copper.

Depending on the feed material(s) used, further steps may be incorporated into the above process of the invention. For example, more particularly:
in the case where the feedstock is a copper-gold-silver sulfide concentrate the process may consist of the following steps:
   a) performing steps (i) to (iv), (vi) to (viii) and (x), and optionally steps (v), (ix) and/or (xii), but recovery of copper in step (vii) between steps (iii) and (iv), rather than after step (iv), optionally preceded by neutralisation of free acid using limestone, forming a gypsum product for separation and recovery, and optionally performing an additional step of heat-treating (54) the separated leach residue (26) from the pressure or atmospheric oxidation leaching (18) after step (iii), thereby to to volatilize any carbonaceous minerals, optionally capturing CO₂ from the heat-treatment (54) using amines or other suitable scrubbing agents as per step (v), and optionally recovering residual sulfur by sublimation and condensation;
   b) repeating steps (ii) to (iv), (vi) to (viii) and (x), and optionally steps (v), (ix) and/or (xii), but using a non-oxidative HCl leach in step (ii), to yield a gold-rich siliceous residue after repeated step (x), and to recover silver metal in repeated step (vii), wherein in the separation step (vi) (34), hydrochloric acid is recovered by distillation for recovery or recycling into the process, the gypsum product (30) is precipitated for recovery, and silver metal (36) is separated by adsorption or other method and recovered (38) by electrowinning or reduction (40), optionally with hydrogen generated by the the hydrogen generator (12) of step (i) or further optionally by brine electrolysis (56);
   c) subjecting the gold-rich siliceous residue of step (b) to oxidative HCl leaching in step (ii) with oxidizing leach reagent produced via the hydrogen generator (12) of step (i) or optionally by brine electrolysis (56), followed by repeating steps (iii) to (iv), (vi) to (viii) and (x), and optionally steps (v), (ix) and/or (xii), wherein in the separation step (vi) (34) sulfuric acid is added to the purified metals (36) to remove calcium, hydrochloric acid is recovered by distillation for recovery or recycling into the process, a gypsum product (30) is precipitated for recovery, and gold metal is separated by adsorption or other method and recovered by electrowinning or reduction (40), optionally with hydrogen generated by the hydrogen generator (12) of step (i) or further optionally by brine electrolysis (56).

Alternatively in the case where the feedstock is a nickel sulfide flotation concentrate containing gold and PGMs, more particularly the process may consist of the following steps:
(A) performing steps (i) to (iv), (vi) to (viii) and (x), and optionally steps (v), (ix) and/or (xii), to generate a gold/PGM-rich siliceous residue after step (x);
(B) heat-treating the gold/PGM-rich siliceous residue from step (x) using hydrogen generated by the hydrogen generator (12) of step (i) and optionally capturing CO₂ from the heat-treatment using amines or other suitable scrubbing agents as per step (v), and optionally recovering sulfur by sublimation;
(C) repeating steps (ii) to (iv), (vi) to (viii) and (x), and optionally steps (v), (ix) and/or (xii), but using a non-oxidative HCl leach in step (ii), to yield a gold/PGM-rich siliceous residue after repeated step (x), and to remove gangue and base metals in repeated step (vii), wherein in the separation step (vi) (34), hydrochloric acid is recovered by distillation for recovery or recycling into the process, a gypsum product is precipitated for recovery, and base metals are recovered into an intermediate product for further processing by recycling into step (A);
(D) subjecting the gold/PGM-rich siliceous residue of (D) to oxidative HCl leaching in step (ii) with oxidizing reagent produced via the hydrogen generator (12) of step (i), or optionally by brine electrolysis (56), followed by repeating steps (iii) to (iv), (vi) to (viii) and (x), and optionally steps (v), (ix) and/or (xii), wherein after step (vi) (34), hydrochloric acid is recovered by distillation or direct recycling of solution into step (C) for recovery or recycling into the process, a gypsum product (30) is precipitated for recovery, and after separation by ion-exchange, solvent extraction or other suitable methods, gold and PGM metals are recovered by reduction (40), optionally with hydrogen generated by the hydrogen generator (12) of step (i) or further optionally by brine electrolysis (56).

Optionally, in either or both of (A), (C) or (D) above, step (iv) may be followed by a secondary neutralisation step by addition of limestone and/or hydrated or dry lime to produce a slurry comprising a nickel-cobalt/iron mixed hydroxide precipitate and gypsum.

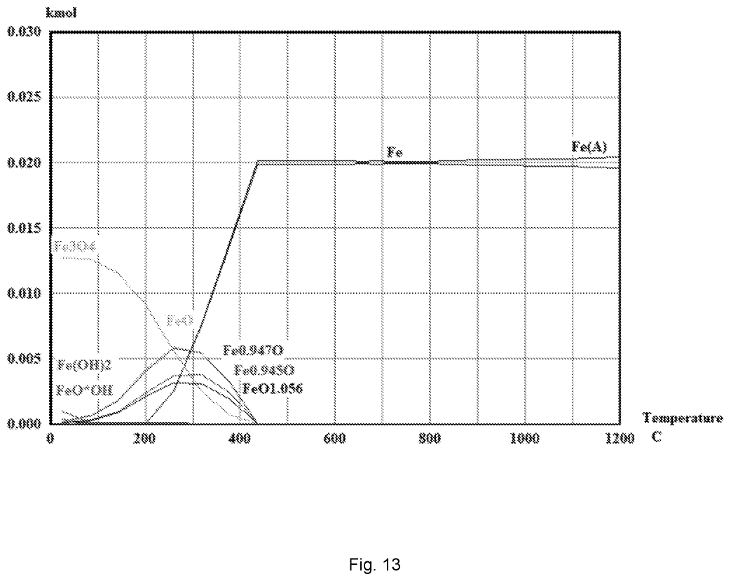

In the case of using the conventional hydrogen reduction route that produces DRI, the potential thermodynamics are shown in FIG. 13 for direct iron reduction with hydrogen. The process is as set out in the below equations, where carbon monoxide is used for conventional carbon-based iron/steel production, and hydrogen generated by electrolysis, pyrolysis or reforming is used for hydrogen-based iron/steel production:

3 Fe₂O₃+CO/H₂=2 Fe₃O₄+CO₂/H₂O (1)

Fe₃O₄+CO/H₂=3 FeO+CO₂/H₂O (2)

FeO+CO/H₂=Fe+CO₂/H₂O (3)

As indicated in the processes above, there is an optional additional inclusion in the process of a brine electrolyser (56), to produce reagents for use in the leach or metals recovery unit processes, or for sale, including using renewable energy or waste sources for the reagent generation. The brine shown in Example 11 below is sodium chloride, but may alternatively be another saline brine. “Saline brine” is a high-concentration solution of salt (usually chloride, with counterions comprising metals such as sodium, potassium, magnesium, calcium, aluminium, iron or other cations) in water.

In the chlor-alkali configuration, reagents including chlorine gas, hydrochloric acid, hypochlorite solution or salts are produced, in addition to hydrogen gas, which can then be used within the process, such as disclosed in Example 9 below. In an alternative or parallel chlorate configuration, an oxidising reagent such as sodium chlorate is produced in addition to the hydrogen gas which is used within the process.

It is to be appreciated that quicklime or hydrated lime could be used in complete or partial replacement of limestone for the neutralisation and purification step (iv).

The feed material ore, concentrate, or residue may be initially processed by crushing, milling or may be as-mined. Alternatively, or in addition, the feed material may be subjected to a beneficiation step to produce an intermediate ore product for providing to the reaction vessel. The beneficiation step may be performed by a combination of crushing, grinding, screening, sizing, classification, magnetic separation, electrostatic separation, froth flotation or gravity separation thereby to concentrate the valuable metals or reject a gangue component, or by other means of beneficiation known to those skilled in the art.

The heat-treatment may be performed at from or about 80-750° C. for up to 120 minutes, typically at from or about 300-700° C. for 10 to 30 minutes, under oxidizing, neutral or reducing conditions, to remove volatile components from the solid residue, optionally including sulfur, and reduce or negate any preg-robbing attributes of the material, whilst rendering refractory mineral phases such as PGM-bearing minerals or silver jarosites suitable for recovery by subsequent leaching.

An additional second heat-treatment may be performed at from or about 500-1000° C. for up to 120 minutes, typically at from or about 700-1000° C. for 30 to 120 minutes, under oxidizing, neutral or reducing conditions, to condition saleable metals to be soluble in chloride leaching medium.

A third additional heat-treatment may be performed at from or about 100-600° C. for up to 240 minutes, typically at from or about 100-400° C. for 60-180 minutes, under oxidizing, neutral or reducing conditions, to further condition saleable metals to be soluble in chloride leaching medium.

The thermal processes may be performed as individual steps of a sequential thermal treatment process, or as one combined step. The thermal processes may be fired by hydrogen generated by the hydrogen generator (12) of step (i), by liquid natural gas or another hydrocarbon fuel, by renewable electricity or a combination thereof. Hydrogen generated by the hydrogen generator (12) of step (i), from a hydrocarbon fuel or from syngas may be used to provide the reducing atmosphere if required.

The terms “element”, “mineral” and “metal” are used interchangeably in this specification.

“Saleable metals”, “saleable elements”, “valuable metals”, “value metals” or “value elements” are used interchangeably and mean any element or metal that is able to generate a revenue through sale of the element or metal in metallic form or as a salt or precipitate of the metal or element.

“PGMs” mean ruthenium (Ru), rhodium (Rh), palladium (Pd), osmium (Os), iridium (Ir), and platinum (Pt).

“Precious metals” means gold, (Au), silver (Ag), and PGMs.

As used herein, “base metals” means industrial non-ferrous metals excluding the precious metals, and including aluminum, copper, lead, nickel, tin, tungsten, zinc, cadmium and manganese. “Rare earth elements” or REEs means a group of chemically similar metallic elements comprising the lanthanide series (fifteen elements), scandium and yttrium. “Rare metals” means a group of metals including the rare earths, lithium, germanium, gallium, indium, scandium and other nominal valuable metals that may be worth recovering, including uranium, thorium, molybdenum and vanadium.

“Pressure oxidation leach” or POX means a process of sulfuric acid (H₂SO₄) leaching comprising either or a combination of a conventional atmospheric (20-100° C.), low (100-130° C.) medium (130-220° C.) or high (220-260° C.) temperature and pressure leach (roughly 35 bar or 510 psi), with addition of oxygen to generate sulfuric acid from sulfide minerals in the feed material, augmented with sulfuric acid addition when contained sulfur in the feed materials is low.

“Pressure acid leach” or PAL means a process of sulfuric acid (H₂SO₄) leaching comprising either or a combination of a conventional atmospheric (20-100° C.), low (100-130° C.) medium (130-220° C.) or high (220-260° C.−HPAL) temperature and pressure leach (roughly 35 bar or 510 psi), wherein the sulfuric acid is added to the process.

The term “conditioning” means a conventional atmospheric (20-100° C.) or low (100-130° C.) temperature and pressure leach with or without the addition of sulfuric acid.

A “pre-conditioned leach residue” means a leach residue previously treated by means of a hot acidic conditioning step, i.e. a conventional atmospheric (20-100° C.) or low (100-130° C.) temperature and pressure leach using sulphuric acid, or a hot alkaline conditioning step, i.e. a lime boil at a pH value of 10-14.

“HCl leach” denotes the process whereby elements are leached from a solid feed by hydrochloric acid or acidified saline brine without addition of an oxidising reagent such as chlorine gas or a reductant, or with addition of a reducing agent such as metal powders, sulfur dioxide producing chemicals, organic reagents, sulfide compounds or concentrates to achieve an oxidation-reduction potential (ORP) setpoint. The leach is performed at atmospheric pressure and at a temperature of from about 60° C. to 90° C., more preferably at about 70° C.

“Oxidative HCl leach” means a conventional atmospheric (20-100° C.) or low (100-130° C.) temperature and pressure leach under oxidising conditions whereby elements are leached from a solid feed by hydrochloric acid (HCl) or saline brine in conjunction with an oxidising agent such as chlorine, hypochlorite, nitric compounds, hydrogen peroxide or others known to those skilled in the art.

An “atmospheric leach step” means a conventional atmospheric (20-100° C.), temperature and pressure H₂SO₄ leach step.

### EXAMPLES

Typically, different combinations of techniques are required, depending on specific feed mineralogy, chemistry and metallurgical response. The following examples are provided to demonstrate the efficacy of the described technique that have been brought to bear to treat specific feed materials. These examples should in no way be interpreted to in any way limit the scope of the invention, and are for illustration only.

### Example 1 Treatment of a Primary Nickel Sulfide Concentrate

In this example, a nickeliferous flotation concentrate containing nickel, cobalt and copper and iron is subjected to sulfuric acid pressure oxidation (“POX”) leach using oxygen generated by a hydrogen generator including by electrolysis of water or hydrocarbon pyrolysis or reforming. Non-limiting examples of methods of hydrogen generation that could be used are known to those skilled in the art^{1, 2, 3, and 4}. The POX slurry is filtered and washed and the solid POX residue containing iron oxide is physically separated from the slurry for recovery of iron oxide. Most of the iron in the POX residue is typically in the form of iron oxide (hematite or goethite) already. However, if significant sulfate minerals are present, the POX residue slurry can be subjected to an additional conditioning step to remove sulfates prior to filtration of the slurry. The remaining pregnant leach solution after removal of the solid residue is subjected to solvent extraction for recovery of copper, optionally preceded by neutralisation of free acid using limestone, forming a gypsum product for separation and recovery. The remaining solution is then neutralised and purified by addition of limestone and air enriched with oxygen generated by the hydrogen generator to remove dissolved iron and sulfate to form solid gypsum and iron oxide products, which are separated from the solution using physical separation methods. Carbon dioxide generated from the neutralisation step is captured, optionally using amines or other suitable scrubbing agents, and then reacted with hydrogen from the hydrogen generator, forming a methanol product. If desired, the recycled carbon dioxide generated from the neutralisation step can be fed into an algal production step^{5, 6, and 7}. Iron oxide is converted to “green steel” or a “green steel” precursor using hydrogen from the hydrogen generator. Nickel and cobalt metals are recovered from the purified pregnant leach solution after gypsum and iron oxide product removal by reduction with hydrogen generated by the hydrogen generator. The steps of physical separation in this example can be performed by filtration, thickening, centrifugation or other standard methods.

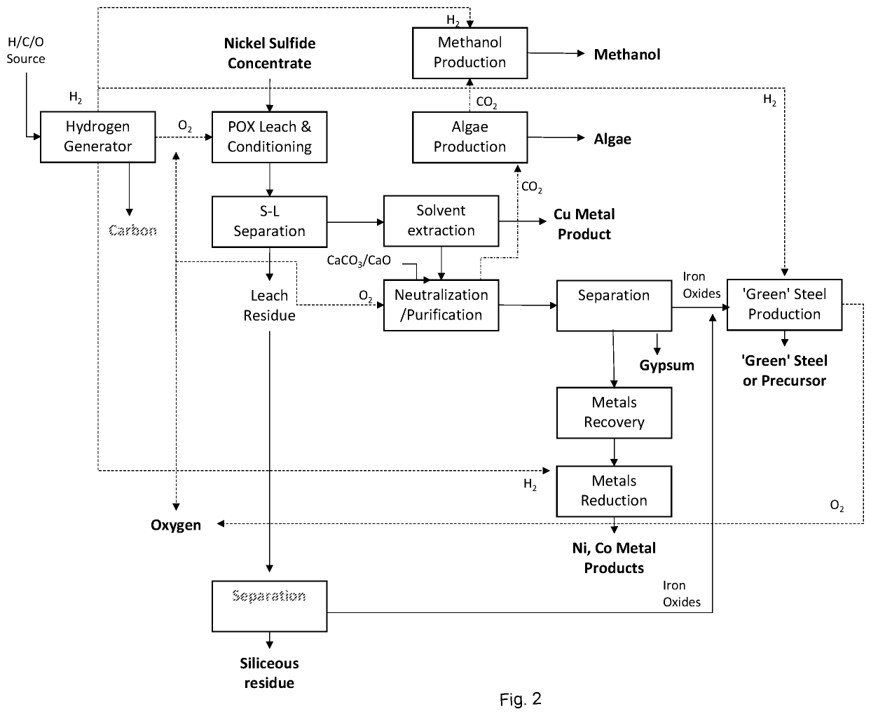

FIG. 2 is a simplified block flowsheet diagram illustrating more detail of this one example of implementation of this invention.

Pressure oxidation tests were completed in a 2 L laboratory batch autoclave under different conditions on samples of two nickel sulfide concentrates with different mass ratios of Fe: Ni, respectively 1.6 and 3.1. The salient results are summarised in Table 1. Extractions of Ni, Cu and Co into solution were >97% in both tests. The residue from Test 1 assayed ˜65% Fe, falling within the industry standard NYMEX traded 62% Fe specification, indicating that this iron oxide product may be converted to “green steel” or a “green steel” precursor using hydrogen from a hydrogen generator.

TABLE 1
Pressure oxidation of a primary nickel sulfide concentrate

| | Co | Cu | Fe | Ni | S |
|---|---|---|---|---|---|
| Head Assay, % | | | | | |
| Concentrate 1 | 1.9 | 3.2 | 33.4 | 20.5 | 30.8 |
| Concentrate 2 | 1.3 | 2.1 | 41.7 | 13.6 | 32.8 |
| Residue Assay, % | | | | | |
| Concentrate 1 | 0.0 | 0.0 | 64.5 | 0.2 | 1.5 |
| Concentrate 2 | 0.0 | 0.0 | 34.0 | 0.1 | 20.9 |
| Extraction, % | | | | | |
| Concentrate 1 | 100 | 100 | 2 | 100 | 98 |
| Concentrate 2 | 98 | 97 | 30 | 98 | 79 |

### Example 2 Treatment of a Primary Nickel Oxide Ore and Sulfide Concentrate

In this example, a blend consisting of a nickel oxide ore and sulfide flotation concentrate containing nickel, cobalt and iron is subjected to sulfuric acid POX leach using oxygen generated by a hydrogen generator as provided in Example 1. The POX slurry is filtered and washed and the solid POX residue containing iron oxide is physically separated from the slurry for the recovery of iron oxide. Most of the iron in the POX residue is typically in the form of iron oxide (hematite or goethite) already. However, if significant sulfate minerals are present, the POX residue slurry can be subjected to an additional acid conditioning step to remove sulfates prior to filtration of the slurry. The remaining pregnant leach solution after removal of the solid POX residue is neutralised and purified by addition of limestone and air enriched with oxygen generated by the hydrogen generator, to remove dissolved iron and sulfate, forming gypsum and iron oxide products which are separated using physical separation methods. Carbon dioxide generated from the neutralisation step is captured, using amines or other suitable scrubbing agents, and reacted with hydrogen generated by the hydrogen generator, forming a methanol product. If desired, the recycled carbon dioxide generated from the neutralisation step can be fed into an algal production step as provided in Example 1. Iron oxide is converted to “green steel” or precursor using hydrogen generated by the hydrogen generator. Nickel and cobalt metals are recovered from the purified pregnant leach solution by reduction with hydrogen generated by the hydrogen generator. The steps of physical separation in this example can be performed by filtration, thickening, centrifugation or other standard methods.

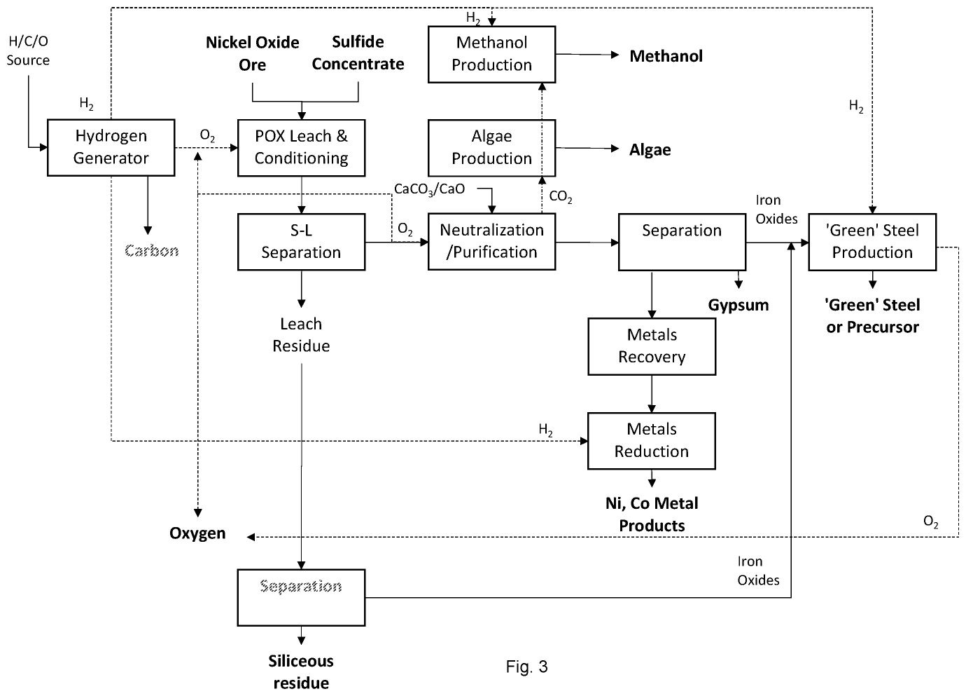

FIG. 3 is a simplified block flowsheet diagram illustrating more detail of this one example of implementation of this invention.

### Example 3 Treatment of a Primary Nickel Oxide Ore

In this example, a nickel oxide ore containing nickel, cobalt and iron is subjected to sulfuric acid leaching, typically sulfuric acid leaching under pressure or atmospheric conditions without adjustment of redox potential, for dissolution of the nickel, cobalt and iron, and the filtered and washed solid leach residue is subjected to a physical separation step to effect the recovery of iron oxide into a separate concentrate stream. Most of the iron in the POX residue is typically in the form of iron oxide (hematite or goethite) already. However, if significant sulfate minerals are present, the POX residue slurry can be subjected to an additional acid conditioning step to remove sulfates prior to filtration of the slurry. The remaining pregnant leach solution after separation from the solid residue is neutralised and purified by addition of limestone and air enriched with oxygen generated by a hydrogen generator as provided in Example 1, to remove dissolved iron and sulfate, forming gypsum and iron oxide products, which are separated using physical separation methods. Carbon dioxide generated from the neutralisation step is captured, using amines or other suitable scrubbing agents, and reacted with hydrogen generated by the hydrogen generator, forming a methanol product. If desired, the recycled carbon dioxide generated from the neutralisation step can be fed into an algal production step as provided in Example 1. Iron oxide is converted to “green steel” or precursor using hydrogen generated by the hydrogen generator. Nickel and cobalt metals are recovered from purified pregnant leach solution by reduction with hydrogen generated by the hydrogen generator. The steps of physical separation in this example can be performed by filtration, thickening, centrifugation or other standard methods.

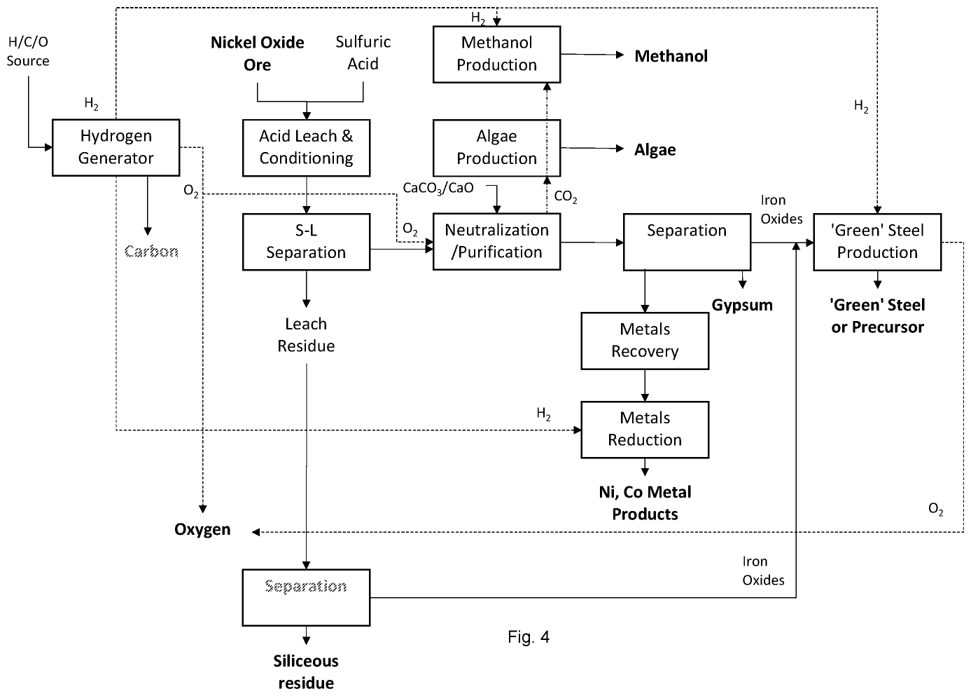

FIG. 4 is a simplified block flowsheet diagram illustrating more detail of this one example of implementation of this invention.

### Example 4 Treatment of a Copper-Gold-Silver Sulfide Concentrate

In this example, a sulfide flotation concentrate containing copper, gold, silver and iron is subjected to sulfuric acid POX leach using oxygen generated by a hydrogen generator as provided in Example 1. The POX slurry is filtered and washed, and the solid POX residue containing iron oxide is physically separated from the slurry into a separate concentrate for the recovery of iron oxide. Most of the iron in the POX residue is typically in the form of iron oxide (hematite or goethite) already. However, if significant sulfate minerals are present, the POX residue slurry can be subjected to an additional acid conditioning step to remove sulfates prior to filtration of the slurry. The remaining pregnant leach solution after separation from the solid POX residue is subjected to solvent extraction for recovery of copper, optionally preceded by neutralisation of free acid using limestone, forming a gypsum product for separation and recovery. The remaining solution is then neutralised and purified by addition of limestone and air enriched with oxygen generated by the hydrogen generator to remove dissolved iron and sulfate to form solid gypsum and iron oxide products, which are separated from the solution using physical separation methods. Carbon dioxide generated from the neutralisation step is captured, using amines or other suitable scrubbing agents, and reacted with hydrogen from the hydrogen generator, forming a methanol product. If desired, the recycled carbon dioxide generated from the neutralisation step can be fed into an algal production step as provided in Example 1. Iron oxide is converted to “green steel” or precursor using hydrogen generated by the hydrogen generator. In this case, the mild sulfuric acid POX conditions result in the presence of elemental sulfur in the POX residue. Moreover, in this example, graphitic and organic carbonaceous material is also present in the flotation concentrate feed and POX residue. Elemental sulfur is therefore recovered by sublimation in a heat treatment step, wherein carbonaceous material is also converted to carbon dioxide, which is captured and reacted with hydrogen to form a methanol product as described above. If desired, the recycled carbon dioxide generated from the neutralisation step can be fed into an algal production step. Gold and silver metals are recovered from the solid POX leach residue after heat treatment by separate leaching steps illustrated in Examples 6 and/or 7. The steps of physical separation in this example can be performed by filtration, thickening, centrifugation or other standard methods.

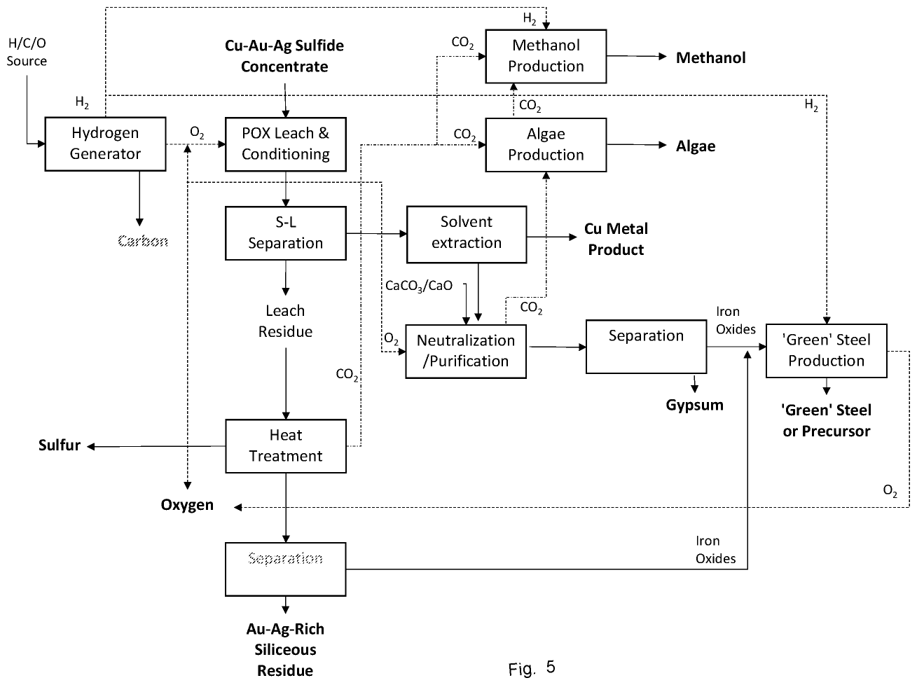

FIG. 5 is a simplified block flowsheet diagram illustrating more detail of this one example of implementation of this invention.

### Example 5 Treatment of a Gold-Silver Sulfide Concentrate

In this example, as provided in Example 1, gold-silver sulfide concentrate is subjected to a sulfuric acid POX leach using oxygen generated by a hydrogen generator as provided in Example 1, and the filtered and washed solid POX residue containing iron oxide is separated from the slurry into a separate concentrate for the recovery of iron oxide. Most of the iron in the POX residue is typically in the form of iron oxide (hematite or goethite) already. However, if significant sulfate minerals are present, the POX residue slurry can be subjected to an additional acid conditioning step to remove sulfates prior to filtration of the slurry. The remaining leach solution after separation of the solid POX residue is neutralised and purified by addition of limestone and air enriched with oxygen generated by the hydrogen generator, to remove dissolved iron and sulfate, forming gypsum and iron oxide products, which are separated from the solution using physical and/or chemical separation methods. Carbon dioxide generated from the neutralisation step is captured, using amines or other suitable scrubbing agents, and reacted with hydrogen generated by the hydrogen generator, forming a methanol product. If desired, the recycled carbon dioxide generated from the neutralisation step can be fed into an algal production step as provided in Example 1. Iron oxide is converted to “green steel” or precursor using hydrogen generated by the hydrogen generator. The steps of physical separation in this example can be performed by filtration, thickening, centrifugation or other standard methods.

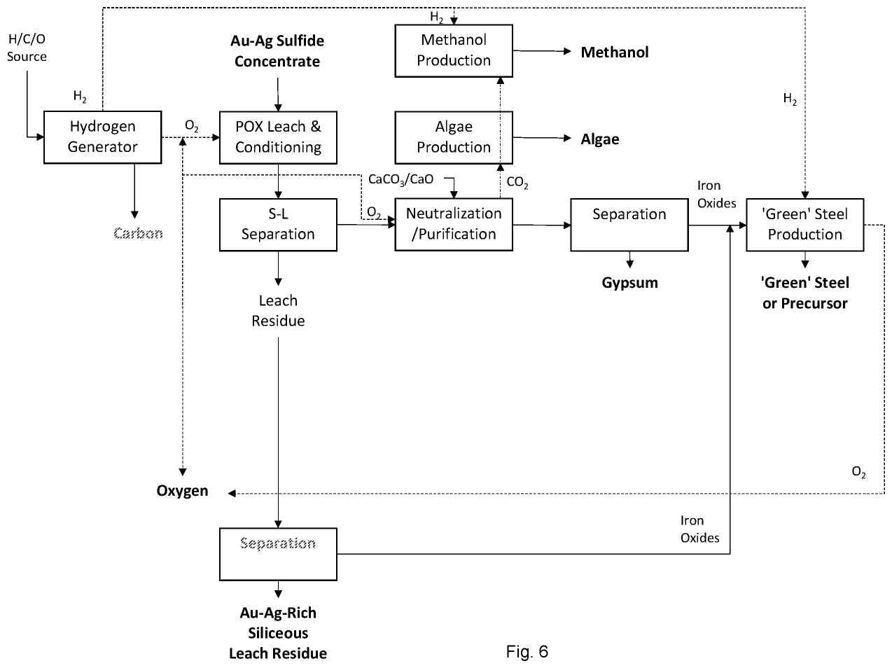

Gold and silver metals are recovered from the solid POX leach residue by a separate leaching step illustrated in Example 6. FIG. 6 is a simplified block flowsheet diagram illustrating more detail of this one example of implementation of this invention.

### Example 6 Treatment of a Gold-Silver-Rich Leach Residue

In this example, the gold-silver-rich solid POX leach residue from Example 4 and/or Example 5 is subjected to reductive/neutral hydrochloric acid leaching for dissolution of silver and residual iron, and the filtered and washed solid leach residue is subjected to a physical or chemical separation step to effect the recovery of iron oxide into a separate concentrate. The remaining leach solution after separation of the solid leach residue is neutralised and purified by addition of limestone and air enriched with oxygen generated by a hydrogen generator as provided in Example 1, to remove dissolved iron, forming an iron oxide product, which is separated from the solution using physical separation methods. Carbon dioxide generated from the neutralisation step is captured, using amines or other suitable scrubbing agents, and reacted with hydrogen generated by the hydrogen generator, forming a methanol product. If desired, the recycled carbon dioxide generated from the neutralisation step can be fed into an algal production step as provided in Example 1. Hydrochloric acid is recovered by distillation after sulfuric acid addition to the solution which also removes calcium, forming a gypsum product. Iron oxide is converted to “green steel” or precursor using hydrogen from the hydrogen generator. Silver metal purified from the leachate solution after removal of iron oxide, hydrochloric acid and gypsum, by reduction with hydrogen generated by the hydrogen generator. The steps of physical separation in this example can be performed by filtration, thickening, centrifugation or other standard methods.

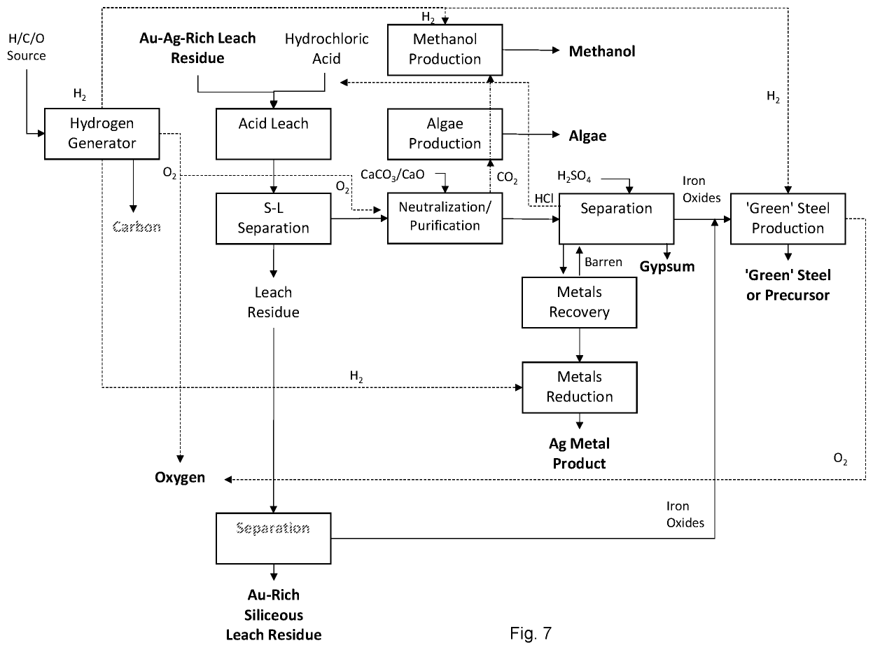

Gold metal is recovered from the solid POX leach residue by a separate leaching step illustrated in Example 7. FIG. 7 is a simplified block flowsheet diagram illustrating more detail of this one example of implementation of this invention.

### Example 7 Treatment of a Gold-Rich Leach Residue

In this example, the gold-rich leach residue containing gold and residual iron from Example 6 is subjected to hydrochloric acid leaching using an oxidant such as chlorine generated by a brine electrolyser or hydrogen peroxide derived from oxygen generated by a hydrogen generator as provided in Example 1, and the filtered and washed solid leach residue is subjected to a physical or chemical separation step to effect the recovery of iron oxide into a separate concentrate. The remaining leach solution after separation from the solid leach residue is neutralised and purified by addition of limestone and air enriched with oxygen generated by the hydrogen generator, to remove residual dissolved iron, forming iron oxide product, which is separated using physical separation methods. Carbon dioxide generated from the neutralisation step is captured, using amines or other suitable scrubbing agents, and reacted with hydrogen generated by the hydrogen generator, forming a methanol product. If desired, the recycled carbon dioxide generated from the neutralisation step can be fed into an algal production step as provided in Example 1. Hydrochloric acid is recovered by distillation after sulfuric acid addition, forming a gypsum product. Iron oxide is converted to “green steel” or precursor using hydrogen from the hydrogen generator. Gold metal product is produced from leachate solution after removal of iron oxide, hydrochloric acid and gypsum, by reduction with hydrogen generated by the hydrogen generator. The steps of physical separation in this example can be performed by filtration, thickening, centrifugation or other standard methods.

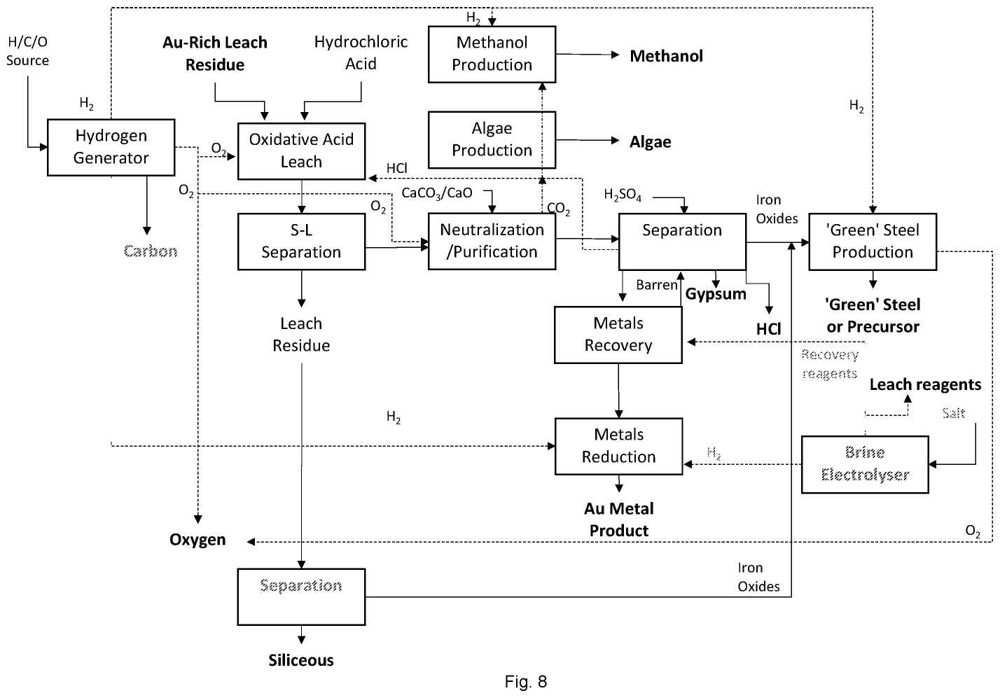

FIG. 8 is a simplified block flowsheet diagram illustrating more detail of this one example of implementation of this invention.

### Example 8 Treatment of a Primary Nickel-PGM Sulfide Concentrate

In this example, a flotation concentrate containing gold, PGM (platinum group metals), nickel, cobalt, copper and iron is subjected to sulfuric acid pressure oxidation (POX) leaching using oxygen generated by a hydrogen generator as provided in Example 1, and the filtered and washed solid POX residue is subjected to a physical separation step to effect the recovery of iron oxide into a separate concentrate. Most of the iron in the POX residue is typically in the form of iron oxide (hematite or goethite) already. However, if significant sulfate minerals are present, the POX residue slurry can be subjected to an additional acid conditioning step to remove sulfates prior to filtration of the slurry. The remaining pregnant leach solution after separation of the solid POX residue is subjected to solvent extraction for recovery of copper, optionally preceded by neutralisation of free acid using limestone, forming a gypsum product for separation and recovery. The remaining solution is then neutralised and purified by addition of limestone and air enriched with oxygen generated by the hydrogen generator to remove dissolved iron and sulfate, forming gypsum and iron oxide products, which are separated from the solution using physical separation methods. Carbon dioxide generated from the neutralisation step is captured, using amines or other suitable scrubbing agents, and reacted with hydrogen from the hydrogen generator, forming a methanol product. If desired, the recycled carbon dioxide generated from the neutralisation step can be fed into an algal production step as provided in Example 1. Iron oxide is converted to “green steel” or precursor using hydrogen from the hydrogen generator. Nickel and cobalt metals are recovered from the leachate solution by reduction with hydrogen from the hydrogen generator, after removal of iron oxide. The steps of physical separation in this example can be performed by filtration, thickening, centrifugation or other standard methods.

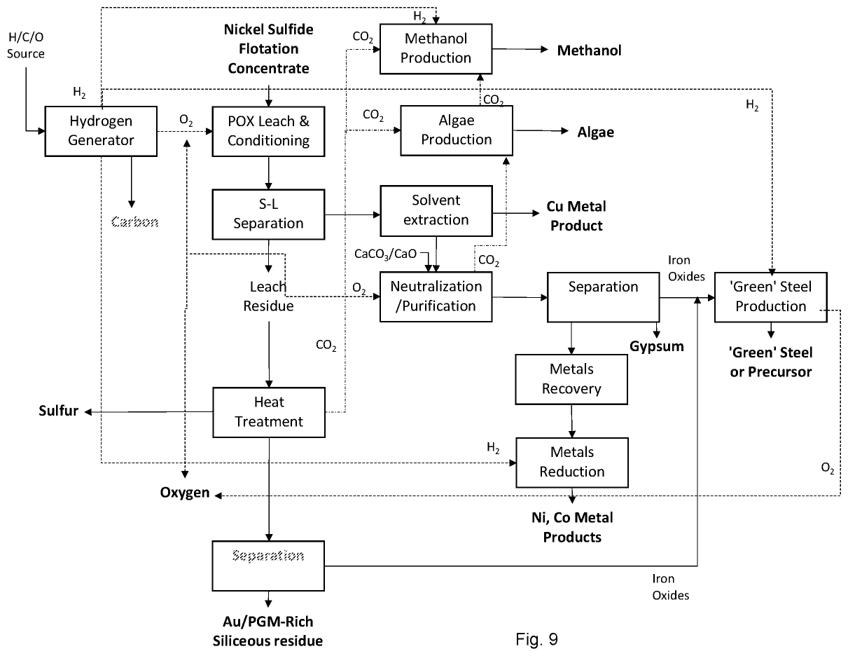

The solid leach residue containing gold, PGM metals, residual iron and elemental sulfur from filtration is subjected to sublimation in a heat treatment pre-conditioning step for recovery of elemental sulfur, wherein carbonaceous material remaining in the leach residue is also converted to carbon dioxide, which is captured, using amines or other suitable scrubbing agents, and reacted with hydrogen generated by a hydrogen generator, forming a methanol product. Gold and PGM metals are recovered from the solid leach residue, which also contains elemental sulfur after the POX leach step, after removal of iron oxide by a separate leaching step illustrated in Example 9. FIG. 9 is a simplified block flowsheet diagram illustrating more detail of this one example of implementation of this invention.

### Example 9 Treatment of a PGM-Rich Leach Residue

In this example, the heat-treated residue from Example 8 is then subjected to hydrochloric acid leaching using using an oxidant such as hydrogen peroxide derived from oxygen generated by the hydrogen generator as provided in Example 1, and the filtered and washed solid leach residue is subjected to a physical or chemical separation step to effect the recovery of iron oxide into a separate concentrate. The remaining leach solution after separation of the solid leach residue is neutralised and purified by addition of limestone and air enriched with oxygen generated by the hydrogen generator, to remove dissolved iron, forming iron oxide product, which is separated using physical separation methods. Carbon dioxide generated from the neutralisation step is captured, using amines or other suitable scrubbing agents, and reacted with hydrogen from the hydrogen generator, forming a methanol product. If desired, the recycled carbon dioxide generated from the neutralisation step can be fed into an algal production step as provided in Example 1. Iron oxide is converted to “green steel” or precursor using hydrogen from the hydrogen generator. PGM and gold metal products are separated from the leach solution after the neutralisation step using standard ion exchange or solvent extraction (IX/SX) techniques, and then recovered from the ion exchange eluate or solvent extraction strip solution by reduction with hydrogen generated by the hydrogen generator. The steps of physical separation in this example can be performed by filtration, thickening, centrifugation or other standard methods.

The steps illustrated in this example may be preceded by the equivalent steps but with a non-oxidising HCl leach, to remove gangue and base metals.

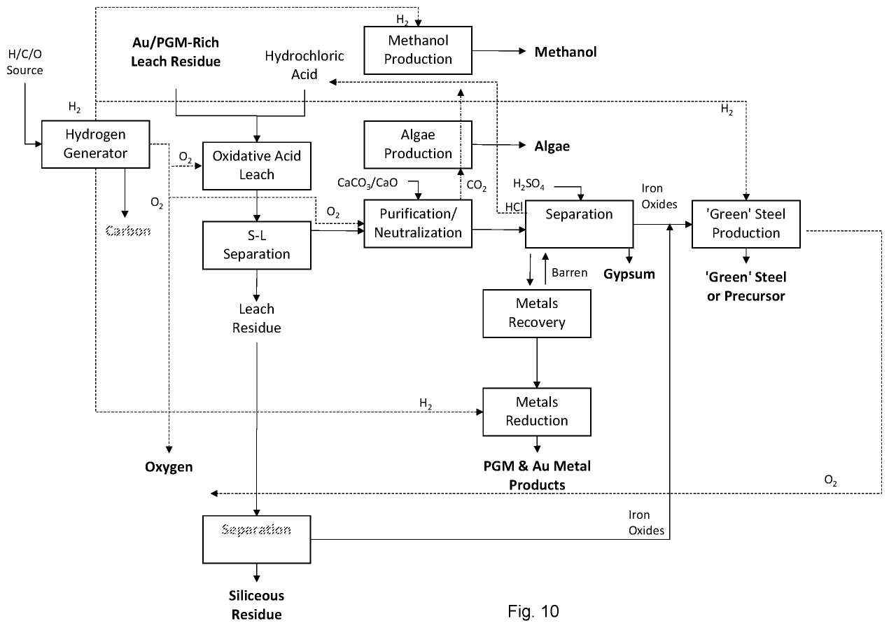

FIG. 10 is a simplified block flowsheet diagram illustrating more detail of this one example of implementation of this invention.

A pressure oxidation test was completed in a 2 L laboratory batch autoclave on a sample of primary nickel-PGM sulfide concentrate. The salient results are summarised in Table 2. Extractions of Ni, Cu, Co and S into solution were >95%. The residue assayed ˜20% Fe, with Fe extraction into solution of <1%. The residue was heat treated and then subjected to an atmospheric HCl preleach, recovering some 67% of the Fe into solution, along with substantially the remainder of the residual base metals. PGMs are retained in the residue for further processing and recovery.

TABLE 2
Pressure oxidation of a primary nickel sulfide concentrate

| | Co | Cu | Fe | Ni | S |
|---|---|---|---|---|---|
| Head Assay, % | | | | | |
| Concentrate | 0.1 | 2.6 | 16.4 | 4.4 | 9.1 |
| POX residue | 0.0 | 0.1 | 21.2 | 0.3 | 0.1 |
| Extraction, % | | | | | |
| POX | 94.5 | 97.9 | 0.9 | 95.4 | 95.4 |
| HCl Preleach | 40.0 | 87.0 | 67.0 | 85.0 | 90.0 |

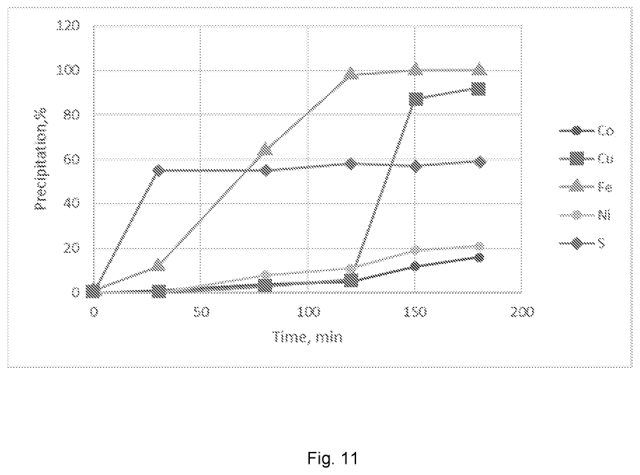

The Fe in the HCl preleach liquor is separated by precipitation using limestone dosing along with air sparging assisted by hydrogen peroxide dosing (which may be derived from oxygen generated by a hydrogen generator), as depicted in FIG. 11. Free calcium is precipitated first as crystalline gypsum, which is separated from the precipitated iron oxide by the method described in Example 11.

The residue assayed ˜57% Fe, falling close to the industry standard NYMEX traded 62% Fe specification, suggesting that this iron oxide product may be converted to “green steel” or a “green steel” precursor using hydrogen from a hydrogen generator.

### Example 10 Hydrogen Production from a Nickel Leach Residue of Example 8

In this example, which is an augmentation of Example 9, the solid leach residue containing gold, PGM metals, residual iron and elemental sulfur from Example 8 is subjected to a heat treatment pre-conditioning and then subjected to hydrochloric acid leaching using hydrogen peroxide derived from oxygen generated by a hydrogen generator as provided in Example 1. The filtered and washed solid leach residue is then subjected to a physical or chemical separation step to effect the recovery of iron oxide into a separate concentrate. The remaining leach solution after separation is neutralised and purified by addition of limestone and air enriched with oxygen generated by the hydrogen generator, to remove dissolved iron, forming iron oxide product, which is separated using physical separation methods. Carbon dioxide generated from the neutralisation step is captured, using amines or other suitable scrubbing agents, and reacted with hydrogen generated by the hydrogen generator, forming a methanol product. If desired, the recycled carbon dioxide generated from the neutralisation step can be fed into an algal production step as provided in Example 1. Iron oxide is converted to “green steel” or precursor using hydrogen from the hydrogen generator. PGM and gold metal products are separated from the leach solution after the neutralisation step using standard IX/SX techniques, and then recovered from the ion exchange eluate or solvent extraction strip solution by reduction with hydrogen generated by the hydrogen generator.

However, in this augmentation of Example 9, a brine electrolyser is further used to produce reagents for use in the leach or metals recovery unit processes, or for sale. The brine shown in this example is sodium chloride, but may alternatively be another halogen salt, such as calcium or magnesium chloride. In the chlor-alkali configuration, reagents including chlorine gas, hydrochloric acid, hypochlorite solution or salts are produced, in addition to hydrogen gas, which can then be used within the process, such as disclosed in Example 9. In an alternative or parallel chlorate configuration, an oxidising reagent such as sodium chlorate is produced in addition to the hydrogen gas which is used within the process, as disclosed in Example 9. The steps of physical separation in this example can be performed by filtration, thickening, centrifugation or other standard methods.

The steps illustrated in this example may be preceded by the equivalent steps but with a non-oxidising HCl leach, to remove gangue and base metals.

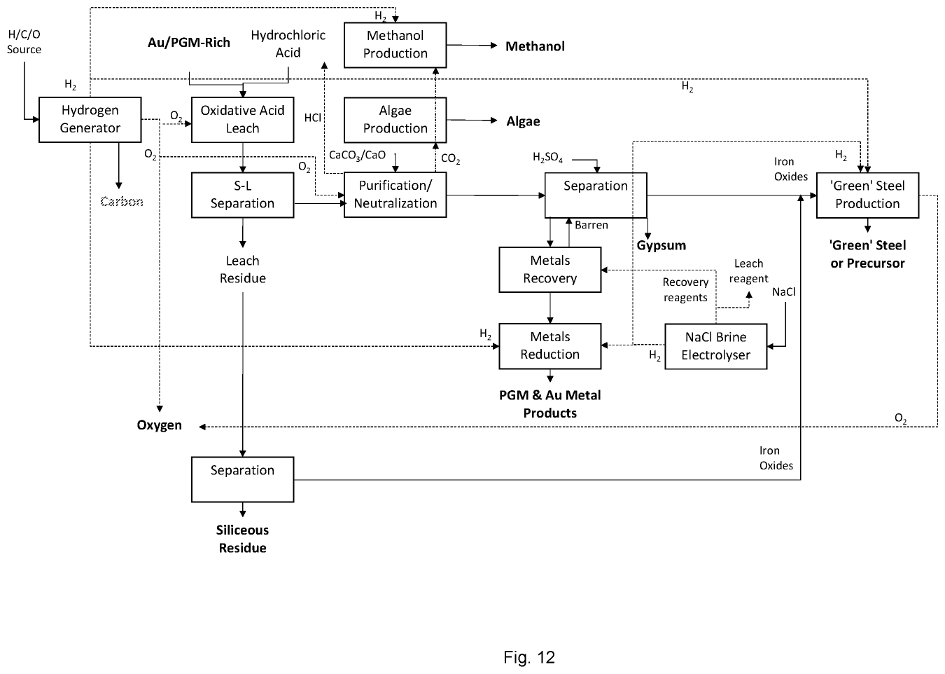

FIG. 12 is a simplified block flowsheet diagram illustrating more detail of this one augmented example of implementation of this invention.

### Example 11 Treatment of a Primary Nickel-PGM Sulfide Concentrate

In this example, which is an augmentation of Example 8, the remaining solution after copper solvent extraction is then neutralised and purified by addition of limestone and air enriched with oxygen generated by the hydrogen generator as provided in Example 1, to form a mixed iron hydroxide and gypsum slurry. After solid-liquid separation, this is followed by the addition of slaked lime slurry to form a mixed nickel, cobalt hydroxide and gypsum slurry. Either slurry is subjected, with or without dewatering, to physical or chemical separation methods to separate gypsum. In this specific, non-limiting, example, a hydrocyclone is used to effect the separation of gypsum, to produce a gypsum-bearing underflow slurry and metals hydroxide-bearing overflow slurry, as shown in Table 3.

TABLE 3
Hydrocyclone separation of gypsum from metal hydroxides

| | Yield | Co | Cu | Fe | Ni | S | Ca |
|---|---|---|---|---|---|---|---|
| Sample | % | % | % | % | % | % | % |
| OF1 | 24 | 63 | 63 | 56 | 63 | 18 | 16 |
| UF1 | 76 | 37 | 37 | 44 | 37 | 82 | 84 |
| OF2 | 22 | 65 | 65 | 58 | 65 | 16 | 14 |
| UF2 | 78 | 35 | 35 | 42 | 35 | 84 | 86 |
| OF3 | 19 | 65 | 66 | 58 | 66 | 13 | 11 |
| UF3 | 81 | 35 | 34 | 42 | 34 | 87 | 89 |
| OF4 | 16 | 66 | 66 | 56 | 67 | 9 | 8 |
| UF4 | 84 | 34 | 34 | 44 | 33 | 91 | 92 |
| OF5 | 16 | 66 | 66 | 57 | 67 | 10 | 8 |
| UF5 | 84 | 34 | 34 | 43 | 33 | 90 | 92 |

The underflow (UF) solids are then subjected to dilute sulfuric acid leaching to readily dissolve any entrained metal hydroxides, given the well-known low aqueous solubility of gypsum:

CaSO₄=Ca²⁺+SO₄²⁻log₁₀Ksp=−4.58 (4)

Typically, the sulfuric acid addition is 5-50% excess above the stoichiometric requirements of the neutralisation reactions, for example:

Ni(OH)₂+H₂SO₄=NiSO₄+2H₂O (5)

Co(OH)₂+H₂SO₄=CoSO₄+2H₂O (6)

2Fe(OH)₃+3H₂SO₄=Fe₂(SO₄)₃+6H₂O (7)

Mn(OH)₂+H₂SO₄=MnSO₄+2H₂O (8)

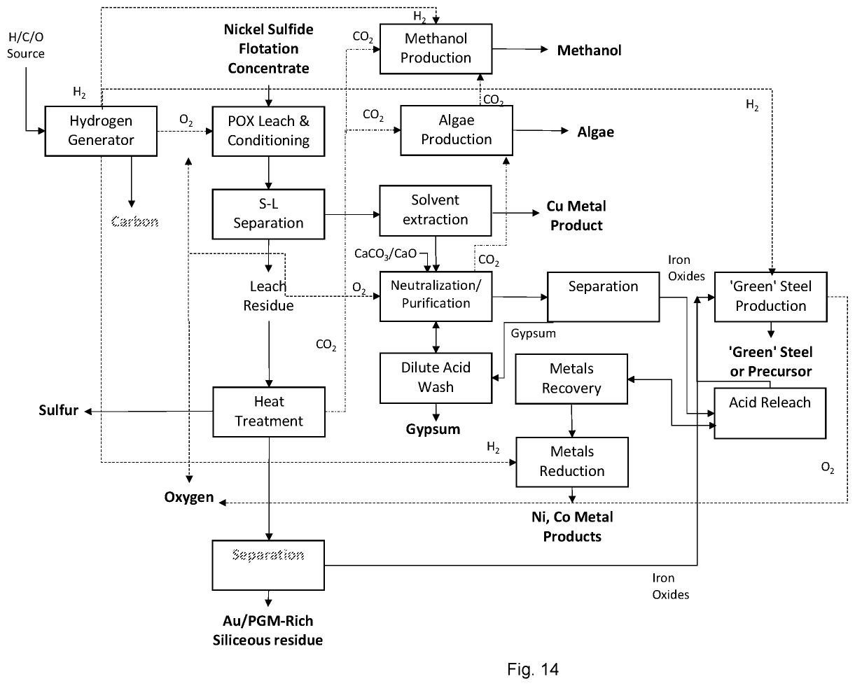

In this example, as illustrated in FIG. 14, pregnant leach solution feed from the neutralisation step is used in this leach step. For the purpose of clarity, a single neutralisation stage only is depicted, although two stages at different pH value setpoints may be preferred, to effect separation of metals. The leachate solution from this leach step is then separated from the solid gypsum by conventional solid-liquid separation techniques, leaving a purified gypsum product for disposal or sale, while the leachate solution is recycled back to the neutralisation step, followed by recovery of nickel and cobalt metals from the mixed nickel, cobalt and iron oxide.

The overflow (OF) solids are also subjected to dilute sulfuric acid releaching to yield a slurry comprising a dissolved nickel and cobalt leachate solution, and a solid residue containing mainly iron oxides and some impurities such as manganese. The selective leaching of nickel and cobalt hydroxides from iron (III) oxides is illustrated in the diagram depicted in FIG. 14, showing solubility dependence on pH value, resulting in the chemical separation of nickel and cobalt in solution (Eqs. 5 and 6) from iron and manganese in the residue (Eqs. 7 and 8).

The dissolved nickel and cobalt leachate solution is then separated from the solid iron oxide by conventional solid-liquid separation techniques, to yield a purified iron oxide product for conversion to green steel or a precursor, and the dissolved nickel and cobalt leachate solution is then recycled to the metals recovery step for reduction with hydrogen from the hydrogen generator for recovery of nickel and cobalt.

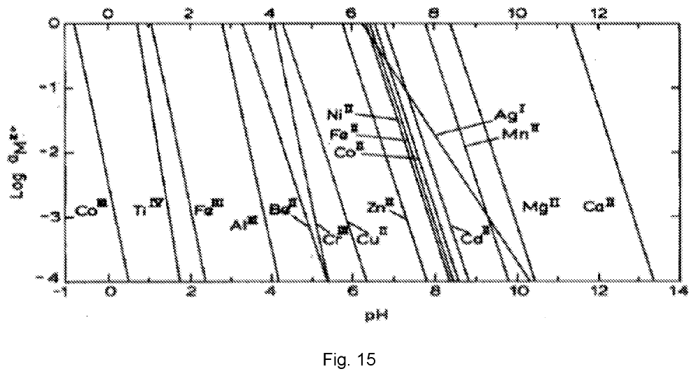

FIG. 15 is a simplified block flowsheet diagram illustrating more detail of this one example of implementation of this invention, which may equally be applied to all examples given above.

### REFERENCES

¹K Mayhew, R Mean, L O'Connor and T Williams, NICKEL AND COBALT RECOVERY FROM MESABA CONCENTRATE, ALTA, Ni/Co Conference 2009, Perth Australia. ALTA Metallurgical Services Pty Ltd. 16 pp;
²Mitsuo MAMIYA, Isao MATSUOKA, Yulan XUE, Fundamental Study on the Separation of Iron Hydroxide and Gypsum Precipitated in the Neutralization Process by Flotation Method (2nd Report), Journal of the Mining and Metallurgical Institute of Japan, 1982, Volume 98, Issue 1132, Pages 501-505;
³Xiaoqian Peng, Jiayi Zheng, Qian Liu, Qimei Hu, Xing Sun, Jie Li, Weizhen Liu, Zhang Lin, Efficient removal of iron from red gypsum via synergistic regulation of gypsum phase transformation and iron speciation, Science of The Total Environment Volume 791, 15 Oct. 2021, 148319;
⁴EP2279151A1;
⁵S. K. Kawatra, T. C. Eisele and Kyle Shoop, Separation of Flue-Gas Scrubber Sludge into Marketable Products. Second Year, Third Quarterly Technical Progress Report, Performance Period: Mar. 1, 1995 to 5/3 1/95 (Quarter #7). Contract No. DE-FG22-93PC93214, U. S. Department of Energy, Pittsburgh Energy Technology Center, Pittsburgh, Pennsylvania, June 1995.9 pp;
⁶https://digital.library.unt.edu/ark:/67531/metadc622580/m2/1/high res d/125374.pdf
⁷James Vaughan, William Hawker, David White, CHEMICAL ASPECTS OF MIXED NICKEL-COBALT HYDROXIDE PRECIPITATION AND REFINING, ALTA, Ni/Co Conference 2011, Perth Australia. ALTA Metallurgical Services Pty Ltd. 13 pp;
⁸WO2002048042A1;
⁹US4036941A;
¹⁰https://onlinelibrary.wiley.com/doi/10.1002/cben.202000014;
¹¹https://www.energy.gov/sites/default/files/2021-09/h2-shot-summit-panel2-methane-pyrolysis.pdf;
¹²https://www.energy.gov/sites/prod/files/2017/05/f34/thermochem_borole_2.5.5.403. pdf;
¹³https://www.synergenmet.com/hydrogen-production)
¹⁴https://www.energy.gov/sites/prod/files/2017/09/f37/algae_cultivation_for_carbon_capture_and_utilization_workshop.pdf
¹⁵https://www.nrel.gov/docs/fy01osti/29417.pdf
¹⁶https://www.biofuelsdigest.com/bdigest/2020/07/05/greening-your-beer-with-brewerys-co2-eating-algae-blockchain-tracing-converting-brewery-waste-into-detergents-and-more/

1. A hydrometallurgical process for extraction and recovery, from a feed material or blend of feed materials, of one or more valuable metals or elements comprising or consisting of: precious metals selected from a group comprising or consisting of platinum group metals (PGMs) i.e. platinum, palladium, rhodium, iridium, ruthenium, osmium, gold and silver; and/or base metals selected from a group comprising or consisting of aluminum, copper, lead, nickel, cobalt, tin, tungsten, zinc, cadmium and manganese; and/or optionally rare elements selected from a group comprising or consisting of rare earth elements, lithium, germanium, gallium, indium, scandium, uranium, thorium, molybdenum and vanadium;
wherein iron-rich waste in the feedstock is converted into “green steel” or a “green steel” precursor, the process comprising or consisting of the following steps:
(i) generating hydrogen and optionally carbon and/or oxygen products with the use of a hydrogen generator, including by electrolysis of water or hydrocarbon pyrolysis or reforming, including with the use of renewable energy or waste sources;
(ii) leaching the feed material or the blend of feed materials, selected from a group comprising or consisting of a sulfide or other concentrated ore, an oxide or laterite ore, a leach residue or a pre-conditioned leach residue, or any combination thereof, under pressure and/or atmospheric conditions and oxidative, neutral or reductive conditions with H₂SO₄ to generate a slurry comprising metal sulfates and other valuable elements in solution and a solid leach residue comprising valuable metals and other valuable elements, including where the feed material or blend of feed materials is in the form of a mineral sulfide concentrate, pressure or atmospheric oxidative leaching with H₂SO₄ the feed material or blend to generate a slurry comprising metal sulfates and other valuable elements in solution and a solid leach residue comprising valuable metals and other valuable elements;
(iii) separating using using filtration, thickening, centrifugation/cycloning, particle size separation techniques, gravity separation, electrostatic separation, the solid leach residue from the solution in the leach slurry;
(iv) in the case where the valuable metal sulfate in solution is copper, after the separation step (iii), purifying and recovery of copper including by solvent extraction, ion exchange, adsorption, precipitation, cementation, electrowinning or reduction;
(v) neutralising and purifying, by addition of limestone and optionally air enriched with oxygen generated from the hydrogen generator, the valuable metals other than copper in the separated solution, thereby to form a slurry comprising the purified metals, solid gypsum and iron oxide products and releasing carbon dioxide;
(vi) optionally, capturing released carbon dioxide produced during the neutralising and purifying step, further optionally using scrubbing agents including amines;
(vii) separating the solid gypsum and iron oxide products from each other and from the purified metals using filtration, thickening, centrifugation/cycloning, particle size separation techniques, gravity separation, or electrostatic separation;
(viii) recovering the purified metals after separation including by solvent extraction, ion exchange, adsorption, precipitation, cementation, electrowinning or reduction;
(ix) optionally reacting the carbon dioxide produced or captured in step (vi), including with the use of scrubbing agents, during the neutralising and purifying step with hydrogen generated by the hydrogen generator to form methanol for sale, storage, or recycling into step (i);
(x) optionally, alternatively or in addition, utilising the carbon dioxide produced or captured, including with the use of scrubbing agents, during the neutralising and purifying step in an algal production system;
(xi) recovering remaining iron oxide from the solid leach residue of step (iii), including optionally subjecting the solid leach residue to heat treatment under reducing, neutral or oxidising conditions to form a heat-treated calcine residue, followed by an additional separation of the solid iron oxide from the calcine residue using filtration, thickening, centrifugation/cycloning, particle size separation techniques, gravity separation, magnetic, or electrostatic separation, leaving a remaining siliceous residue optionally comprising valuable metals and other elements for further purification;
(xii) reacting the separated iron oxide products from step (vii) and step (xi) including by a molten salt electrolysis route to produce oxygen, or alternatively by hydrogen reduction using hydrogen generated by the hydrogen generator in step (i), to produce Direct Reduced Iron (DRI) or sponge iron, thereby forming “green steel” or a precursor thereof and optionally oxygen, depending on the “green steel” or precursor thereof production process used; and
(xiii) optionally capturing released oxygen, when produced in step (xii), for reuse in the hydrometallurgical process.

2. The hydrometallurgical process according to claim 1, wherein the oxygen generated from hydrogen generation of step (i), and/or if generated in the iron reduction step (xii) is used in step (ii).

3. The hydrometallurgical process according to claim 1, wherein in step (viii), the reduction is performed using hydrogen from the hydrogen generation step (i).

4. The hydrometallurgical process according to claim 1, wherein in step (ix), the methanol is recycled to the hydrogen generation step (i) to generate carbon, including for processing to form a stable saleable by-product such as carbon black, graphite, graphene or carbon nanotubes, as well as hydrogen and oxygen for use in the hydrometallurgical process.

5. The hydrometallurgical process according to claim 1, wherein in step (xii), the reaction process includes the use of renewable energy sources to produce the “green steel” or precursor.

6. The hydrometallurgical process according to claim 1, wherein in the case where significant jarosite or basic ferric sulfate is present in the solid residue for step (ii) the leach slurry is subjected to a conditioning step to leach iron sulfates into solution.

7. The hydrometallurgical process according to claim 1, wherein step (v) further includes a step of partial reduction of the slurry using hydrogen produced by the hydrogen generator or with another reductant, to form one or more magnetic iron phases that are separated from the gypsum by magnetic separation.

8. The hydrometallurgical process according to claim 1, wherein step (v) is followed by a secondary neutralisation step comprising or consisting of:
a. addition of limestone and/or hydrated or dry lime to produce a slurry comprising a nickel-cobalt/iron mixed hydroxide precipitate and gypsum;
b. separating the gypsum from the nickel-cobalt/iron mixed hydroxide precipitate by filtration, thickening, centrifugation/cycloning, particle size separation techniques, gravity separation, magnetic, or electrostatic separation;
c. subjecting the separated gypsum to sulfuric acid washing, followed by recycling to step (viii) to recover entrained nickel and cobalt in the gypsum and to produce a gypsum product for disposal or sale;
d. subjecting the separated nickel-cobalt/iron mixed hydroxide precipitate to sulfuric acid releaching to produce a solution comprising nickel and cobalt sulfates and an iron oxide hydrate containing impurity metals including manganese, for disposal or advancing to step (viii); and
e. optionally, after step a. or b. subjecting the slurry or separated solid nickel-cobalt/iron mixed hydroxide precipitate and gypsum to an oxidising leach step with sulfuric acid, to yield gypsum, manganese for disposal or recovery by any one of the methods in step (viii), nickel for recovery by any one of the methods in step (viii), and cobalt, optionally for subjecting to further leaching.

9. The hydrometallurgical process according to claim 1, wherein, in the case where the feedstock is a copper-gold-silver sulfide concentrate, the process consists of the following steps:
I) performing steps (i) to (iii), (v), (vii), (viii), (xi) and (xii), and optionally steps (iv), (vi), (ix), (x) and/or (xiii), and optionally performing an additional step of heat-treating the separated leach residue from the pressure or atmospheric oxidation leaching after step (iii), thereby to volatilize any carbonaceous minerals, optionally capturing CO₂ from the heat-treatment, further optionally using amines or other suitable scrubbing agents as per step (vi), and optionally recovering residual sulfur by sublimation and condensation;
II) repeating steps (ii), (iii), (v), (vii), (viii), (xi) and (xii), and optionally steps (iv), (vi), (ix), (x) and/or (xiii), but using a non-oxidative HCl leach in step (ii), to yield a gold-rich siliceous residue after repeated step (xi), and to recover silver metal in repeated step (viii), wherein in the separation step (vii), hydrochloric acid is recovered by distillation for recovery or recycling into the process, the gypsum product is precipitated for recovery, and silver metal is separated by adsorption and recovered by electrowinning or reduction, optionally with hydrogen generated by the hydrogen generator of step (i) or further optionally by brine electrolysis;
III) subjecting the gold-rich siliceous residue of step (II) to oxidative HCl leaching in step (ii) with oxidizing leach reagent produced via the hydrogen generator of step (i) or optionally by brine electrolysis, followed by repeating steps (iii), (v), (vii), (viii), (xi) and (xii), and optionally steps (iv), (vi), (ix), (x) and/or (xiii), wherein in the separation step (viii) sulfuric acid is added to the purified metals to remove calcium, hydrochloric acid is recovered by distillation for recovery or recycling into the process, a gypsum product is precipitated for recovery, and gold metal is separated by adsorption and recovered by electrowinning or reduction, optionally with hydrogen generated by the hydrogen generator of step (i) or further optionally by brine electrolysis.

10. The hydrometallurgical process according to claim 1, wherein, in the case where the feedstock is a nickel sulfide flotation concentrate containing gold and PGMs, the process consists of the following steps:
(A) performing steps (i) to (iii), (v), (vii), (viii), (xi) and (xii), and optionally steps (iv), (vi), (ix), (x) and/or (xiii), to generate a gold/PGM-rich siliceous residue after step (xi);
(B) heat-treating the gold/PGM-rich siliceous residue from step (xi) using hydrogen generated by the hydrogen generator of step (i) and optionally capturing CO₂ from the heat-treatment, further optionally using amines or other suitable scrubbing agents as per step (vi), and optionally recovering sulfur by sublimation;
(C) repeating steps (ii), (iii), (v), (vii), (viii), (xi) and (xii), and optionally steps (iv), (vi), (ix), (x) and/or (xiii), but using a non-oxidative HCl leach in step (ii), to yield a gold/PGM-rich siliceous residue after repeated step (xi), and to remove gangue and base metals in repeated step (viii), wherein in the separation step (vii), hydrochloric acid is recovered by distillation for recovery or recycling into the process, a gypsum product is precipitated for recovery, and base metals are recovered into an intermediate product for further processing by recycling into step (A);
(D) subjecting the gold/PGM-rich siliceous residue of step (C) to oxidative HCl leaching in step (ii) with oxidizing reagent produced via the hydrogen generator of step (i), or optionally by brine electrolysis, followed by repeating steps (iii), (v), (vii), (viii), (xi) and (xii), and optionally steps (iv), (vi), (ix), (x) and/or (xiii), wherein after step (viii), hydrochloric acid is recovered by distillation or direct recycling of solution into step (D) for recovery or recycling into the process, a gypsum product is precipitated for recovery, and after separation including by ion-exchange or solvent extraction, gold and PGM metals are recovered by reduction, optionally with hydrogen generated by the hydrogen generator of step (i) or further optionally by brine electrolysis.

11. The hydrometallurgical process according to claim 10, wherein in either or both of steps (A), (C) or (D), step (v) is followed by a secondary neutralisation step by addition of limestone and/or hydrated or dry lime to produce a slurry comprising a nickel-cobalt/iron mixed hydroxide precipitate and gypsum.

12. The hydrometallurgical process according to claim 9, wherein the heat treatment is performed at from or about 80-750° C. for up to 120 minutes, or at from or about 300-700° C. for 10 to 30 minutes, under oxidizing, neutral or reducing conditions.

13. The hydrometallurgical process according to claim 12, wherein a second heat-treatment is performed at from or about 500-1000° C. for up to 120 minutes, or at from or about 700-1000° C. for 30 to 120 minutes, under oxidizing, neutral or reducing conditions.

14. The hydrometallurgical process according to claim 13, wherein a third heat-treatment is performed at from or about 100-600° C. for up to 240 minutes, or at from or about 100-400° C. for 60-180 minutes, under oxidizing, neutral or reducing conditions.

15. The hydrometallurgical process according to claim 13, wherein the thermal processes are performed as individual steps of a sequential thermal treatment process, or as one combined.

16. The hydrometallurgical process(es) according to claim 9, wherein the heat is generated by hydrogen generated by the hydrogen generator of step (i), by liquid natural gas or another hydrocarbon fuel, by renewable electricity or a combination thereof.
